(19) United States
(12) Patent Application Publication
(10) Pub. No.: US 2004/0216934 A1
(43) Pub. Date: Nov. 4, 2004

(54) Working vehicle having a hood

(75) Inventors: Yuji Tomiyama, Osaka (JP); Teruhito Yamauchi, Osaka (JP); Satoshi Yoshikawa, Osaka (JP); Atsushi Hayashi, Osaka (JP); Shigeo Sakamoto, Osaka (JP); Mitsuhiko Obe, Osaka (JP)

Correspondence Address: Russell D. Orkin, WEBB ZIESENHEIM LOGSDON ORKIN & HANSON, P.C., 700 Koppers Building, 436 Seventh Avenue, Pittsburgh, PA, 15219-1818, US

(73) Assignee: KUBOTA CORPORATION, Osaka (JP)

(21) Appl. No.: 10/764,135

(22) Filed: Jan. 23, 2004

(30) Foreign Application Priority Data
Jan. 27, 2003 (JP) PAT. 2003-17869
Feb. 3, 2003 (JP) PAT. 2003-26413

(51) Int. Cl. B60K 11/00

(52) U.S. Cl. 180/68.1

(57) ABSTRACT

A working vehicle includes a vehicle body, a radiator mounted on the vehicle body, and a hood provided at a front portion of the vehicle body for covering the radiator. The hood includes a hood body, a front-face grill portion provided at a front face of the hood body for introducing ambient air to the interior of the hood and a pair of side-face grill portions provided at right and left side faces of the hood body for introducing ambient air into the interior of the hood. A rectifier member is provided for controlling the flow of ambient air introduced from a rear portion of the side-face grill portion.

### BACKGROUND OF THE INVENTION

The present invention relates to a working vehicle such as a tractor, having a hood. More particularly, the invention relates to a working vehicle including a vehicle body; a radiator mounted on the vehicle body; and a hood provided at a front portion of the vehicle body for covering the radiator; the hood including a hood body, a front-face grill portion provided at a front face of the hood body for introducing ambient air to the interior of the hood and a pair of side-face grill portions provided at right and left side faces of the hood body for introducing ambient air into the interior of the hood.

### DESCRIPTION OF THE RELATED ART

A conventional hood for a conventional working vehicle is known from e.g. the Japanese Patent Application “Kokai” No.: 2002-192961, which hood includes a front-face grill portion (shown at 14A in FIG. 2 of the document) provided at the front face of the hood body and a pair of side-face grill portions (shown at 14G in the same) provided at the right and left side faces.

With such conventional hood, the side-face grill portions are disposed closer to the radiator than the front-face grill portion and also these side-face grill portions are oriented along the right/left direction (direction normal to the traveling direction of the vehicle) relative to the fore and aft direction of the vehicle body (corresponding to the traveling direction). Therefore, the ambient air passing a rear portion (close to the radiator) of each side-face grill portion tends to have an excessive velocity, thus creating a significant difference relative to the velocity of the ambient air passing a front portion of that side-face grill portion. For this reason, there tends to occur premature localized clogging phenomenon with foreign substance such as bugs, dust, etc., at the rear portion of the side-face grill portion than the remaining portion (e.g. the front portion) of the side-face grill portion and/or at the front-face grill portion. Such clogging reduces the effective grill face area available for entrapping foreign substances, hence, reduction in the entrapping rate of the grill.

In view of the above, an object of the present invention is to improve the entrapping rate for foreign substance through effective prevention of such localized clogging with foreign substance by maximum equalization of velocities of ambient air portions passing respective portions of the side-face grill.

### SUMMARY OF THE INVENTION

For accomplishing the above-noted object, the working vehicle according to the present invention having the above-described construction is characterized by a rectifier member for controlling the flow of ambient air introduced from a rear portion of the side-face grill portion.

With the above, the ambient air having a relatively large velocity is effectively prevented from directly contacting the radiator with maintaining that velocity un-attenuated. Therefore, it becomes possible to prevent the premature localized clogging phenomenon with bugs, dust or any other foreign substance at the rear portion of the side-face grill portion. Hence, the disadvantageous reduction in the effective grill surface area for entrapment and resultant reduction in the substance entrapping efficiency can be avoided.

According to one embodiment, said rectifier member comprises a planar member disposed so as to face the inner side of the rear portion of the side-face grill portion, the planar member being configured for directing the ambient air forwardly. Namely, the direction of the ambient air in the vicinity of the radiator where the velocity of the air is increased is positively changed to the forward direction.

In the above, preferably, the apparatus further comprises a condenser disposed forwardly of the radiator and said rectifier member is adapted for directing the ambient air more forwardly of the condenser.

With this, more of the amount of the ambient air for cooling the radiator may be supplied to the condenser for condensing cooling medium of an air-conditioner used for cooling/heating atmosphere within a cabin.

According to one embodiment, said each side-face grill portion includes a mesh member having a progressively increased aperture from its front end to its rear end. With this, it becomes possible to further reduce the difference between the velocity of the ambient air passing the front portion of the side-face grill portion and the rear portion (near the radiator) of the same, thus achieving even greater equalization of the velocities of the ambient air passing the respective portions of the side-face grill portion.

According to one embodiment, said hood body includes a flange portion facing the side-face grill portion and said rectifier member is formed integrally with said flange portion. This eliminates the need for forming the rectifier member as a separate member and eliminates the further need for fixing means such as a fastener means for securing the rectifier member to the inner face of the hood body. Hence, this is advantageous for reduction of the number of parts to be assembled into the hood and facilitation of the assembly.

According to one embodiment, said rectifier member comprises a planar member disposed so as to face the inner side of the rear portion of the side-face grill portion, the planar member having at least one vent and decelerating the ambient air. Namely, as the ambient air having passed the side-face grill portion is introduced toward the radiator, the velocity of the ambient air in the vicinity of the radiator where the velocity tends to be increased is decreased.

With the above, by means of the rectifier member, the current of the ambient air passing the portion of the side-face grill portion in the vicinity of the radiator is positively decelerated, thus reducing the velocity difference with the ambient air passing the front portion of this side-face grill portion, thereby to achieve maximum equalization in the velocity of the ambient air passing the respective portions of the side-face grill portion. Consequently, it is possible to prevent localized substance clogging at the rear portion of the side-face grill portion, thus achieving improvement in the substance entrapping ratio.

In the above construction, as described hereinbefore, if the side-face grill portion includes a mesh member and said vent has an aperture smaller than that of the mesh member, it becomes possible to more effectively entrap fine dust or the like having passed the mesh of the side-face grill portion also by this side-face grill portion comprising the planar member.

Further, if the mesh member has a progressively increased aperture from its front end to its rear end, it becomes possible to further reduce the difference between the velocity of the ambient air passing the front portion of the side-face grill portion and the rear portion (near the radiator) of the same, thus achieving even greater equalization of the velocities of the ambient air passing the respective portions of the side-face grill portion.

According to one embodiment, the rectifier member is formed integrally with the mesh member. This eliminates the need for forming the rectifier member as a separate member, so that attachment of the rectifier to the hood can be carried out at one time with the attachment of the mesh member to the hood body advantageously.

According to one embodiment, the apparatus further comprises a seal provided along an outer periphery of the radiator for sealing a gap between the radiator outer periphery and the inner face of the hood and a seal receiving face provided on the inner face of the hood for coming into contact with the seal when the hood is closed, wherein said seal projects forwardly toward the seal receiving face and said seal is compressed when the seal receiving face comes into contact with the seal in the fore and aft direction.

With respect to the above, reference is made to a tractor known from the U.S. Pat. No. 5,495,910, which tractor includes an engine disposed at a front portion of a tractor vehicle body, a radiator disposed forwardly of the engine for introducing ambient air from the front area, a pivotally openable/closable hood for covering the upper and right and left sides of the engine and radiator and a seal disposed between the hood and the radiator. With this conventional construction, the gap between the radiator and the inner face of the hood can be sealed by the seal so as to prevent the flow of the hot air having passed the radiator from returning again to the front area of the vehicle, thus avoiding deterioration in cooling efficiency. However, the seal employed by this conventional construction comprises a split construction consisting of separate members of a foam seal (“closed cell foam seal” shown at 42 in FIG. 5 of the document) disposed between the inner side of the top face of the hood and the top of the radiator and a pair of “flapper seals” (shown at 45 in FIG. 5 and FIG. 6 of the same) disposed between the inner side of the respective side faces of the hood and the respective sides of the radiator. Therefore, there is the risk of a gap being formed at the border between the foam seal, and the flapper seals, the gap inviting leak of the hot air therethrough.

Further, the above-described flapper seals are attached to the sides of the radiator so that these seals project outward to the right and left. And, when the hood is closed, each of these flapper seals comes into contact with a rib projecting from the side face of the hood and also with the inner face of the hood. Upon the contact, the seal is bent rearward. and the resilient deformation of the seal from that bent condition provides the adhesive force required for its sealing function. With this construction, friction occurs between the seal and the inner face of the hood in the course of the rearward bending of the seal. As a result, the seal may be worn by the friction prematurely.

In order to avoid such “fictional wear” of the flapper seal, it is conceivable to form this seal shorter so as not to contact the inner face of the hood (i.e. so as to contact only the rib). With this, however, the amount of bending of the flapper seal will be reduced, thus inviting deterioration in its sealing performance.

In the above regard, according to the characterizing feature of the present invention described above, the seal and the seal receiving face come into contact with each other in the fore and aft direction when the hood is closed. Hence, such frictional wear of the seal can be avoided. Moreover, as this seal projects toward the seal receiving face along the fore and aft direction and is compressed in the fore and aft direction in association with its contact to the seal receiving face, the seal can provide reliable sealing effect.

In the above construction, if the hood is pivotally openable/closable about a pivot shaft extending in the right/left direction and said pivot shaft is disposed at a higher level than the top end of the radiator, it becomes possible to cause the contact between the seal receiving face and the seal to take place in a direction even closer to the horizontal direction, whereby the sealing performance can be further improved.

Further, if a reinforcing frame member for reinforcing the hood is provided along the inner face of the hood body and said seal receiving face is formed in this reinforcing frame member, the seal receiving face can be formed by utilizing the reinforcing frame member. Consequently, advantageous further reduction in the number of components and cost reduction can be achieved.

Further and other features and advantages of the invention will become apparent upon reading the following detailed description with reference to the accompanying drawings.

### BRIEF DESCRIPTION OF THE DRAWINGS

FIG. 1 is an overall side view showing a tractor (an example of “working vehicle”) relating to a first embodiment of the present invention,

FIG. 2 is an exploded perspective view of a hood of the tractor shown in FIG. 1,

FIG. 3 is a perspective view showing an assembled condition of the tractor shown in FIG. 2,

FIG. 4 is a side view of the hood,

FIG. 5 is a top plan view of the hood,

FIG. 6 is a schematic plan view illustrating flow of ambient air passing side-face grill portions,

FIG. 7 is a perspective view for explaining a sealing construction between the hood and a radiator,

FIG. 8 is a partial side view in section of the sealing construction,

FIG. 9 is a partial plan view in section of the sealing construction,

FIG. 10 show a pivot portion of the hood shown in FIG. 2, (a) being a side view and (b) being a plan view,

FIG. 11 is an exploded perspective view corresponding to FIG. 2 showing a hood used in a tractor relating to a second embodiment of the present invention,

FIG. 12 is a partial plan view in section showing the hood shown in FIG. 11,

FIG. 13 is a partial plan view in section showing a hood used in a tractor relating to a third embodiment of the present invention,

FIG. 14 is a partial plan view in section showing a hood used in a tractor relating to a fourth embodiment of the present invention, and

FIG. 15 is a view showing a variation of the side-face grill portion of the hood.

### DESCRIPTION OF THE PREFERRED EMBODIMENTS

With reference to the accompanying drawings, preferred embodiments of the present invention will be described next by way of a tractor as an example of a working vehicle.

### First Embodiment

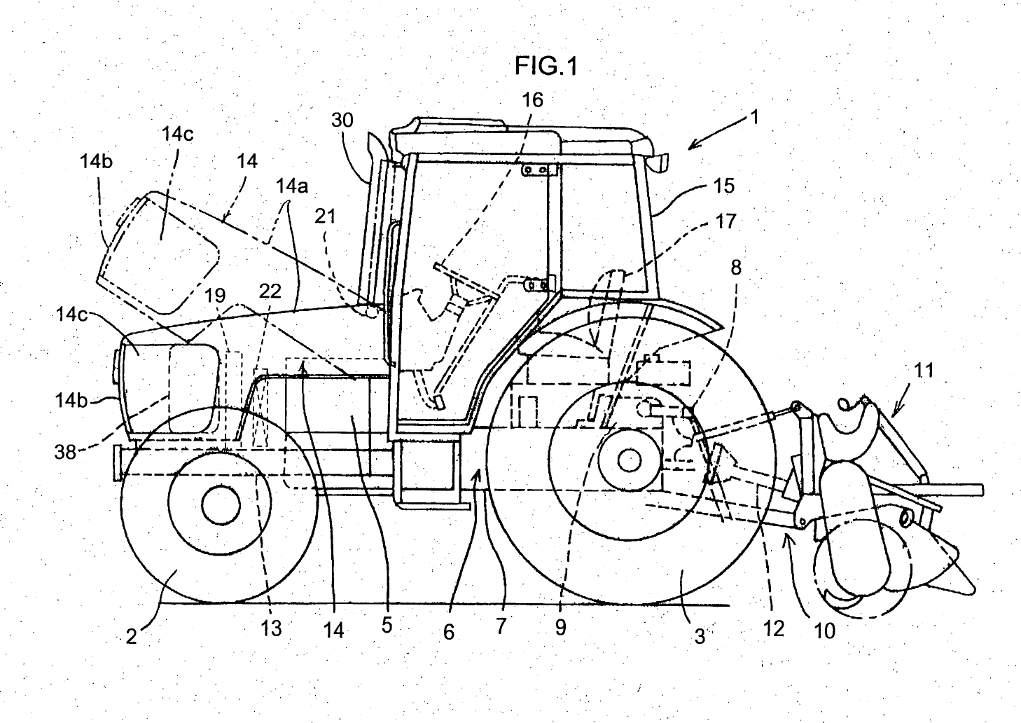

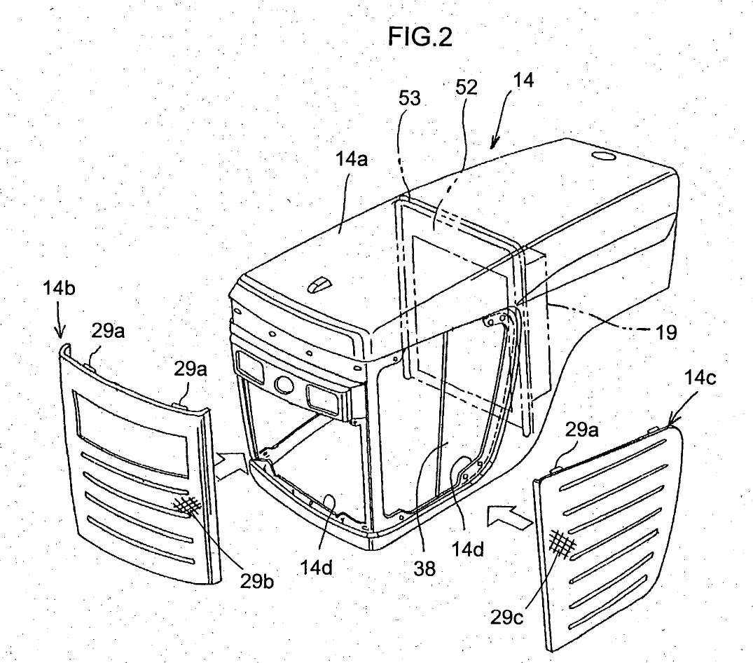

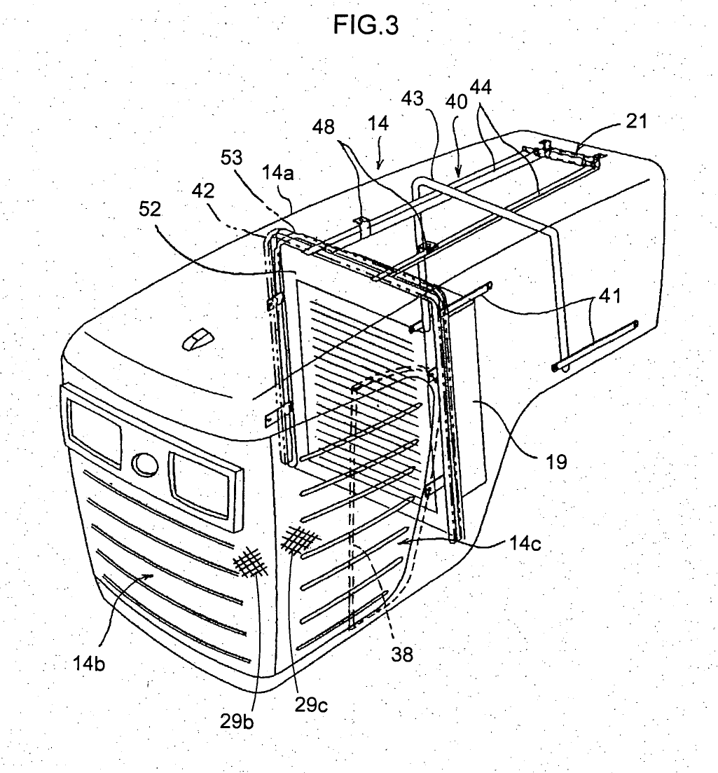

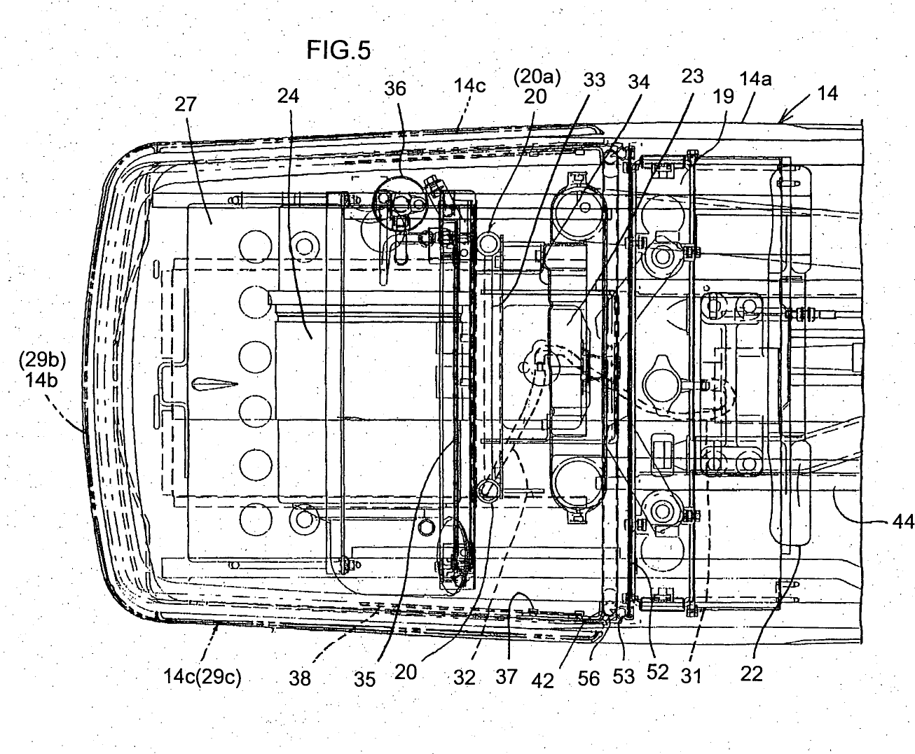

FIGS. 1 through 6 show a first embodiment of the present invention. FIG. 1 shows a tractor 1 having a hood 14 relating to the present invention. In the following discussion, the traveling direction of the tractor 1 will be referred to as the “fore and aft direction” and the direction normal to this fore and aft direction will be referred to as the right/left direction (the sheet depth direction in FIG. 2), respectively.

The tractor 1 is a 2-axle, 4-wheel type vehicle including a pair of right and left front wheels 2 for use in steering and auxiliary traveling drive and a pair of right and left rear wheels 3 for use in main traveling drive. The tractor 1 is switchable into 2-wheel drive mode (rear-wheel drive) or 4-wheel drive mode (front/rear wheel drive) as being driven by an engine 5. The engine 5, a transmission case 7 and other components together constitute a traveling vehicle body 6. The traveling vehicle body 6 mounts, at a rear portion thereof, a hydraulic unit 9 having a lift arm 8. The hydraulic unit 9 is capable of lifting a three-point link mechanism 10 up and down.

The three-point link mechanism 10 is capable of connecting or disconnecting various implements 11 (a tiller in the illustrated example) to the vehicle body. The implement 11 can receive a drive force from the engine 5 through a PTO shaft 12.

Rearwardly of the engine, there is provided a cabin 15 of an independent mount type. A front lower wall of this cabin 15 functions as a partition wall behind the engine 5. On the rear side of the partition wall (i.e. on the front inner face of the cabin 15), there is provided a steering unit having a steering wheel 16 and a driver's seat 17 is disposed behind this steering unit.

The engine 5 is disposed at a front upper portion of the vehicle body 6 and a silencer or muffler 28 is connected to an upper portion of the engine 5, so that exhaust gas from the engine is discharged through an exhaust pipe included in the muffler 28.

At a front portion of the vehicle body 6, there is provided a front-axle frame 13 extending forwardly from the engine 5, and a radiator 19 is mounted on this front-axle frame 13. Further, over the front-axle frame 13 and the vehicle body 6, there is provided a hood 14 covering the various components including the engine 5, the radiator 19, the muffler 28, etc. The hood 14 forms an engine room therein.

The radiator 19 is disposed in front of the engine 5 and designed as a front air-intake type for introducing ambient air from the front rear of the vehicle and sending this as cooling air to the engine 5 disposed behind.

Rearwardly of the radiator 19, there is provided a radiator fan 22, which is operated by a belt transmission means driven by the engine 5 for introducing the ambient air.

Forwardly of the radiator 19, there is provided a support frame 20 for supporting various components including auxiliary devices for the engine, etc. This support frame 20 includes a pair of right and left elongate struts 20a disposed erect on the floor of the engine room a connecting member for connecting the struts 20a together. To the leading ends (upper ends) of the struts 20a, a reservoir tank 23 is secured via the connecting member.

The radiator 19 and the reservoir tank 23 are connected via a first overflow pipe 31, so that cooling water overflowing from the radiator 19 during cool condition of the engine may be transported via the first overflow pipe 31 to be reserved at the reservoir tank 23. Further, the reservoir tank 23 incorporates a second overflow pipe 32 for discharging cooling water overflowing from the reservoir tank 23 to the outside of the engine room.

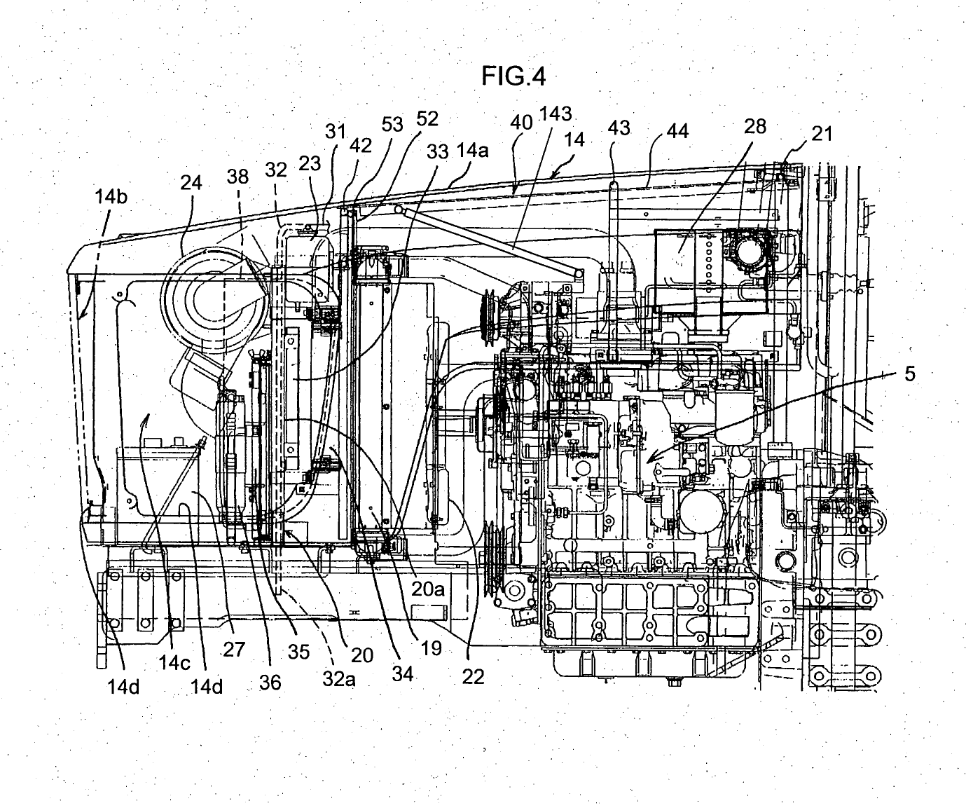

As shown in FIGS. 4 through 6, the struts 20a are secured to the floor through an attaching bracket for attachment to the engine room floor and fixing means such as bolts. The base of this strut 20a is open to as to extend through the floor. Further, the second overflow pipe 32 is inserted into the struts 20a and a discharge opening 32a of the pipe is exposed through the opening of the base to the outside of the engine room so that the cooling water overflowing from the reservoir tank 23 may be discharged via the second overflow pipe 32 from the discharge opening 32a.

Conventionally, the second overflow pipe 32 was inserted into a hole formed in the engine room floor mounting the radiator, with its discharge opening 32a being exposed to the outside of the engine room for discharging the water. With this conventional construction, when a negative pressure developed inside the engine room, there was the risk that dust or the like would easily enter the engine room, thus leading to e.g. clogging of the radiator 19, etc. On the other hand, according to the above-described construction of the present invention, the second overflow pipe 32 is inserted into the strut 20a for discharging water overflowing from the reservoir tank 23. With this construction, if the dust or the like is to enter the engine room, it has to lift up the elongate struts 20a against the gravity. Therefore, it can hardly enter the engine room. As a result, the engine room can be maintained under a cleaner condition, advantageous for maintenance also.

Under the reservoir tank 23, there is disposed an oil cooler 33, which in turn is fixed to the struts 20a via a fixing member. Further, between the radiator 19 and the oil cooler 33, there is provided an inter-cooler 34 for cooling the intake air for the engine 5.

In front of the oil cooler 33, there is provided a condenser 35 for condensing cooling medium, the condenser being included in an air-conditioner for cooling/heating air inside the cabin 15. This condenser 35 is secured to the pair of right and left struts 20a. On the front right side of the condenser 35, there is provided a receiver 36 for reserving the cooling medium condensed by the condenser 35. An air cleaner 24 is disposed above the receiver 36 and a battery 27 is mounted on the engine room floor forwardly of the air cleaner 24.

The hood 14 includes a hood body 14a formed of resin such as synthetic resin, a front-face grill portion 14b attached to the front face of the hood body 14a, and a pair of side-face grill portions 14c attached to the right and left side faces of the hood body 14a forwardly of the radiator 19.

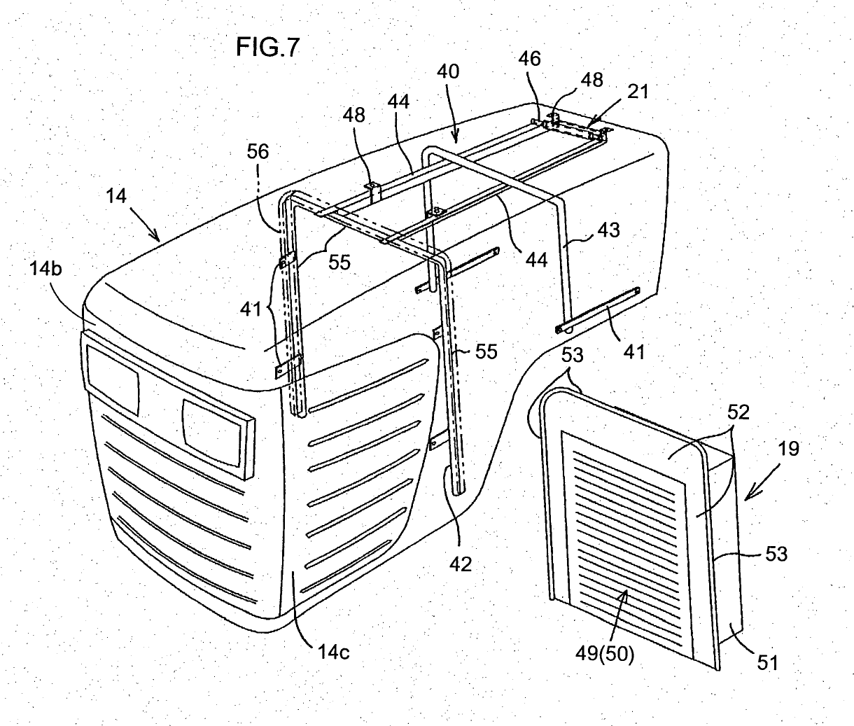

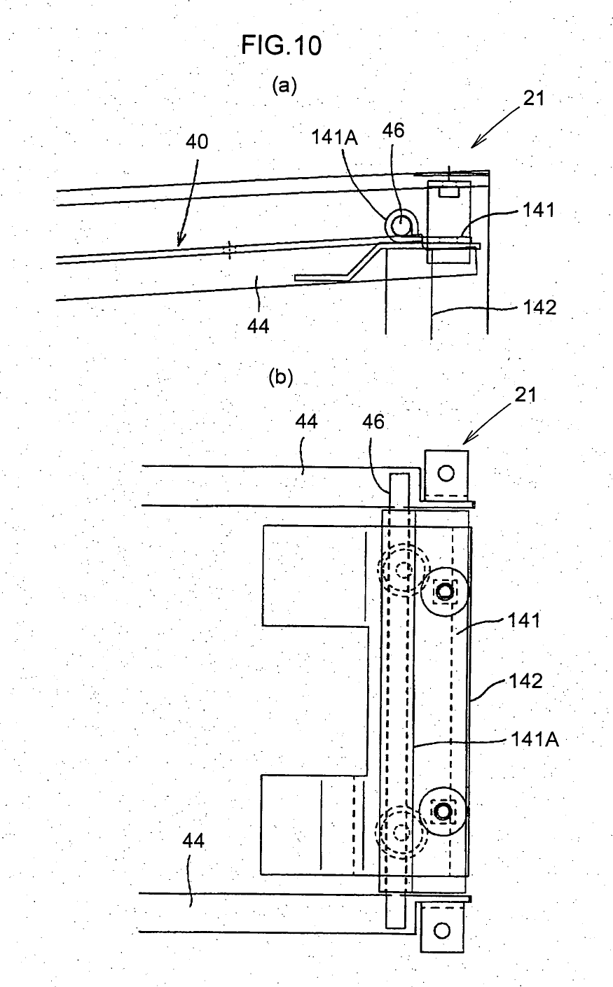

In the following discussion, reference will be made also to FIGS. 7 through 10.

As the hood body 14a is formed of the resin, a reinforcing structure 40 is provided inside the body for adding to its strength.

The reinforcing structure 40 includes a front portal frame (corresponding to “reinforcing frame member”) 42 provided in correspondence to a fore-and-aft intermediate portion of the hood body 14a in which a vertically wide portion of the side face including the side-face grill portion 14a and a rear portal frame 43 provided behind the front portal frame 42 and in correspondence to a vertically narrow portion of the side face. Each of these front and rear portal frames 42, 43 is formed by configuring a pipe member (a solid bar, a flat bar, a channel member, an angle member, etc.) into, the portal shape extending along the upper face or side face portion of the hood body 14a. The front portal frame 42 is attached to the hood 14 via brackets 41 provided at upper lower right/left sides of the frame. The rear portal frame 43 is attached to the hood 14 via brackets provided at lower light and left sides of the frame.

The right and left sides of the front and rear portal frames 42, 43 extend vertically in the side view and the upper sides or portions thereof extend along the right/left direction.

Under the top face of the hood body 14a, there are provided a pair of right and left upper members 44 extending and oriented along the fore and aft direction. This upper member 44 is formed of an elongate member such as an angle member, a channel member, a pipe member, a solid bar, a flat bar, etc. These upper members 44 are attached to the hood body 14 via brackets 48 provided at appropriate positions. The right/left distance between the right and left upper members 44 is designed to be smaller than the right/left widths of the front and rear portal frames 42, 43.

The front end of the upper member 44 is connected to the upper portion of the front portal frame 42 by means of welding, bolt, etc. Also, the fore-and-aft intermediate portion of the upper member 44 is connected to the upper portion of the rear portal frame 43 by means of welding, bolt, etc.

The top face of the hood body 14a is bent downward at its front end and raised upward at its fore-and-aft center portion, so that a gap is formed between the upper members 44 and the lower surface of the top face of the hood and the right/left extending upper side of the rear portal frame 43 is disposed inside this gap.

The upper members 44 extend rearward to the rear portion of the hood body 14a and at the rear ends thereof, there is provided a pivot member (a hinge member in the illustrated example) 21 for pivotally supporting the hood body 14a for its pivotal opening/closing. This pivot member 21 is provided at a front upper portion of the partition wall of the cabin 15 for pivotally supporting a rear upper portion of the hood 14.

The pivot member 21 includes a pivot shaft 46 extending between the right and left upper members 44 and an attaching plate 141 having a cylindrical portion 141A for rotatably receiving, at its front portion, the pivot shaft 46. The attaching plate 141 is attached via bolts or the like to an upper end of a support table 142 mounted erect on the vehicle body 6 behind the engine 5 (immediately forwardly of the cabin 15).

The pivot shaft 46 of the pivot member 21 attached in the manner described above is disposed rearwardly of and at a higher position than the upper end of the radiator 19. Hence, the hood 14 is vertically pivotable about the pivot shaft 46 as its fulcrum. Then, when the hood 14 is pivoted upward as indicated by a virtual line in FIG. 1, the hood 14 is open to expose the components including the engine 5, the radiator 19 etc. Whereas, when it is pivoted downward as indicated by a solid line in FIG. 1, the hood 14 covers these components. Incidentally, inside the hood 14, there is provided an open supporting member (a spring in the illustrated example) 143 for urging the hood 14 in its opening direction. This open supporting member 143 is disposed at a position immediately behind the radiator 19, which position is hardly affected by the heat from the engine 5 or the muffler 28 so that the cooling effect by the radiator 19 can be expected. This arrangement is effective for avoiding unexpected change in the “flipping-up” (opening) speed of the hood 14 due to a rise in gas pressure associated with excessive heat.

The radiator 19 includes a radiator body 50 having a core portion 48 between an upper tank portion 47 and a lower tank portion (not shown), the radiator fan 22 disposed behind the radiator body 50, and a frame member 51 surrounding the periphery (upper/lower and right/left portions) of the core portion 49. This frame member 51 includes a portion extending rearward from the core portion 49 for surrounding the outer periphery of the radiator fan 22.

Around the front portion of the radiator 19 (frame member 51), there is provided a partition member 52 formed of a plate member for partitioning the inside of the engine room in the fore and aft direction at the position of the radiator 19, with the partition member 52 projecting in the outer right and left sides and the upper side. And, a seal 53 is attached to the entire outer edge of this partition member 52. This seal 53 includes an engaging portion 53A for engaging the outer edge of the partition member 52 and a hollow seal portion 53A as the main body of the seal. And, the seal 53 is attached such that the seal portion 53A projects more forwardly than the partition member 52 (i.e. projecting in the fore and aft direction toward a seal receiving face 55 described below).

On the other hand, on the inner surface of the hood body 14a, there is formed the seal receiving face 55 for coming into contact with the seal 53. More particularly, the rear face of the front portal frame 42 is formed as this seal receiving face 55. In operation, when the hood 14 is closed, the front face of the seal 53 comes into contact with the rear face of the front portal frame 42, so that the seal portion 53B of the seal 53 is compressed in the fore and aft direction.

The above provides reliable sealing between the inner face of the hood body 14a and the outer edge of the radiator 19.

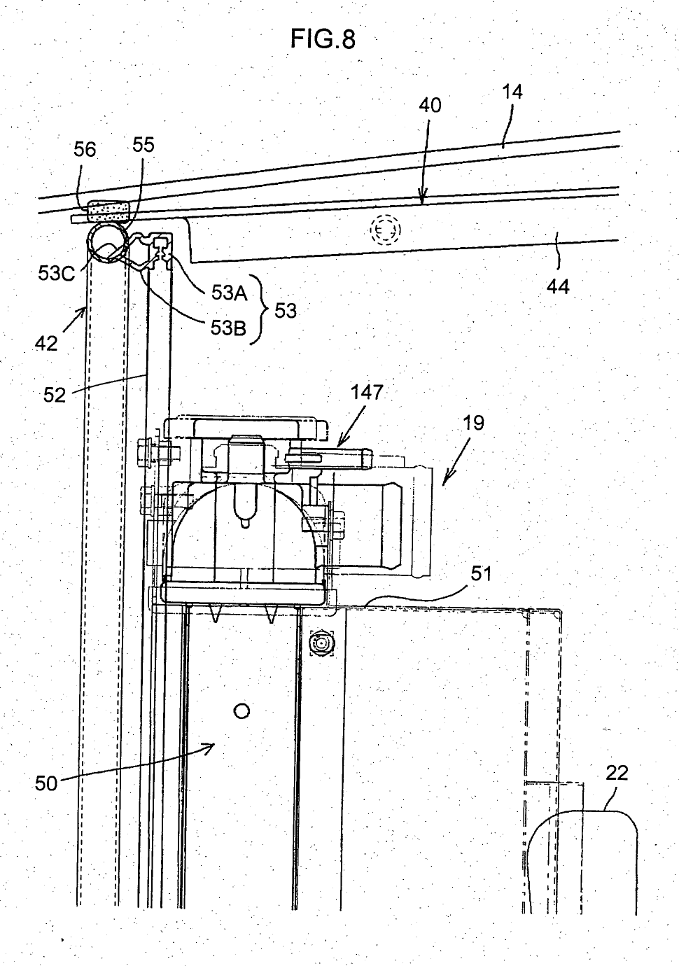

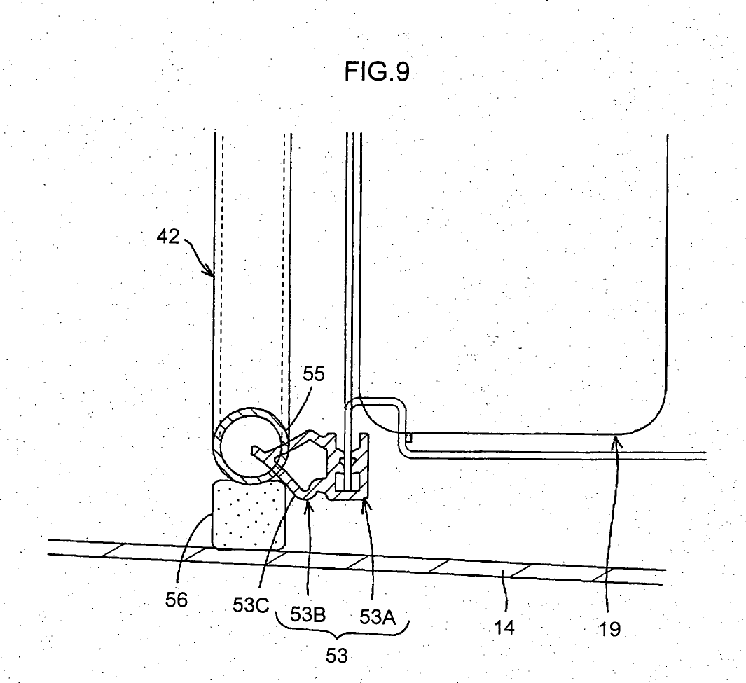

Incidentally, in FIG. 8 and FIG. 9, the seal 53 is shown under a non-compressed, non-deformed condition. In fact, the seal 53 will be deformed flat by the depression from the seal receiving face 55.

A sealing face 53C of the seal 53 is inclined so that its leading end is oriented inward (vertically inward or inward in the right/left direction).

The pivot shaft 46 serving as the fulcrum for the pivotal movement of the hood body 14a is disposed upwardly and rearwardly of the radiator 19 (at a position rearwardly of and higher than the upper end of the partition member 52). Therefore, when the hood body 14a is pivoted in the closing direction (downward), the seal receiving face 55 is shifted rearward immediately before its complete closure. With this, the receiving face 55 can contact the seal 53 in the fore and aft direction substantially without any vertical friction relative thereto. As a result, frictional wear of the seal 53 will hardly occur, and its durability is improved. Further, since the seal 53 and the seal receiving face 55 are formed continuous in the form of inverted U-shape from the upper portions and side portions of the radiator 19 and the hood body 14a, there is formed no partial gap in the extensions thereof.

Along a gap formed between the front portal frame 42 and the inner face of the hood body 14a, there is provided a second seal 56 formed of a foamed material for preventing reverse intake of the hot air through this gap. However, in case there is formed no such gap between the front portal frame 42 and the inner face of the hood boy 14a, this second seal 56 may be omitted.

As shown in FIGS. 2 through 6, the hood body 14a forms openings in its front face and opposed side faces. And, along the peripheral edges of these openings, stepped portions are formed for providing flange portions 14d for engagement with mesh members 29b, 29c of the respective grill portions 14b, 14c. These respective flange portions 14d form screw holes for securing the respective mesh members 29b, 29c. Each of the mesh members 29b, 29c is formed of e.g. a punching metal, and on the inner side thereof, there is provided an attaching bracket 29a having a screw hole.

For forming each grill portion 14b, 14c, each mesh member 29b, 29c is engaged with each flange portion 14d so as to cover each corresponding opening and then under this condition, the screw hole of the attaching bracket 29a will be brought into registry with the screw hole formed in the flange portion 14d and then they are fastened together by fixing means 37 such as a bolt.

Between the radiator 19 and each side-face grill portion 14c, there is provided a rectifier member 38 for controlling the velocity of ambient air passing the portion of the side-face grill portion 14c near the radiator 19. This rectifier member 38 is formed of a planar member configured and disposed so as to face the side-face grill portion 14c, thereby to cover the side-face grill portion 14c from the inside from the rear end to the intermediate portion of this side-face grill portion 14c. This planar member can be various configurations such as a plate-like member, a mesh member, etc. In this particular embodiment, the planar member is formed of a non-porous plate-like member.

The planar member is provided approximately in the form of a rectangle member defining screw holes at upper and lower rear positions, so that the member is secured to the inner side of the hood body 14a via the fastening means 37. Therefore, this planar member, i.e. the rectifier member 38 is secured by the fastening means 37 to the hood body 14a together with the mesh member for the side-face grill portion 14c.

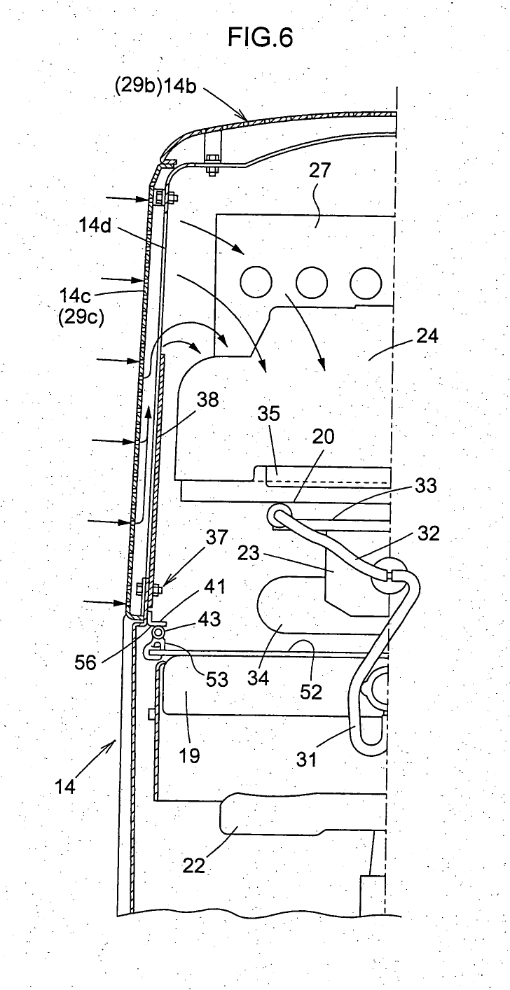

As the rectifier member 38 is provided as described above, the velocity of the ambient air passing the rear portion of each side-face grill portion 14c adjacent the radiator 19, is reduced as being resisted by this rectifier member 38. Further, as shown by the arrow in FIG. 6, this air is oriented more forwardly than the condenser 35 disposed forwardly of the radiator 19. With this, it is possible to avoid direct contact between this ambient air having a relatively high velocity and the radiator 19, so that this air will be converged with other portions of the ambient air passing the front-face grill portion 14b and/or the front portions of the side-face grill portion 14c.

### Second Embodiment

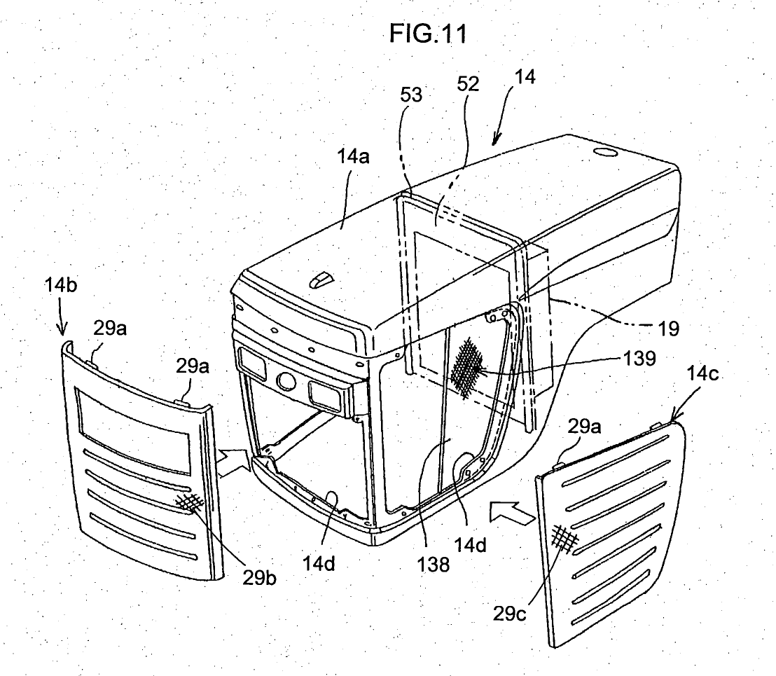

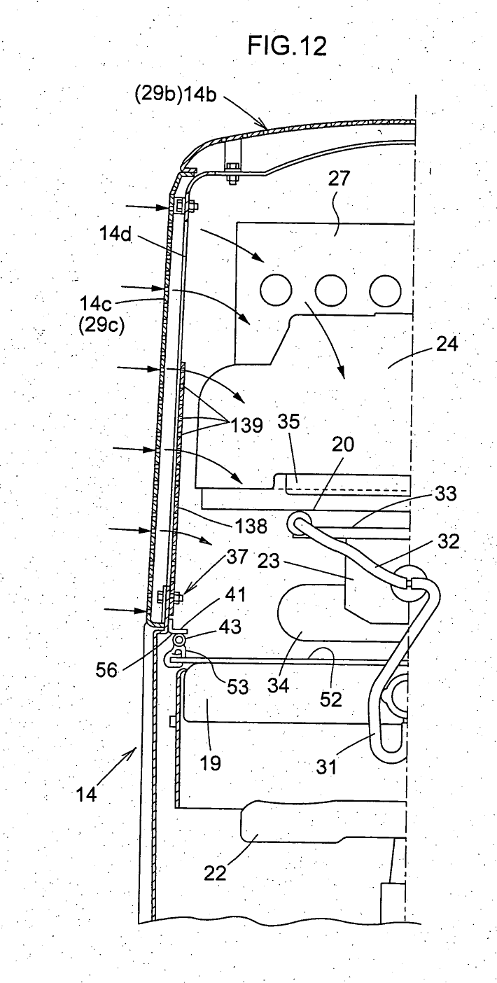

FIGS. 11 and 12 show a second embodiment. In this embodiment, like the rectifier member 38 described and provided in the first embodiment described above, a rectifier member 138 interposed between the radiator 19 and the side-face grill portion 14c is provided as a planar member configured and disposed to face the side-face grill portion 14c so as to over the side-face grill portion 14c from the rear end to the intermediate portion of the side-face grill portion 14c. Different from the planar member of the foregoing embodiment, the planar member employed in this second embodiment is formed as a porous member for allowing passage of the ambient air introduced through the side-face grill portion 14c to the radiator 19. More particularly, this planar member defines a number of vents 139 formed through the thickness thereof. Each of these vents 139 is sized to be slightly smaller than the mesh of the mesh member 29c for the side-face grill portion 14c, so that fine dust or the like having passed the mesh of the side-face grill portion 14c may be entrapped by this planar member. Alternatively, the vent 139 may be sized to be substantially equal to or slightly larger than the mesh of the mesh member 29c.

With the rectifier member 138 designed and provided as described above, when the ambient air passing the rear portion of the side-face grill portion 14c adjacent the radiator 19 is traveling toward the radiator 19, this air current will meet the resistance from the rectifier member 138, so that its velocity is reduced. As a result, it is possible to minimize any velocity difference between this air portion and the other air portion passing the front-face grill portion 14b or the front portion of the side-face grill portion 14c, thus achieving maximum equalization of air velocity. Consequently, it becomes possible to prevent the premature localized clogging phenomenon with bugs, dust or any other foreign substance at the rear portion of the side-face grill portion. Hence, the disadvantageous reduction in the effective grill surface area of the side-face grill portion 14c for entrapment and resultant reduction in its substance entrapping efficiency can be avoided, as the entire surface area of this side-face grill portion 14c is made available for foreign substance entrapment.

In addition, as the rectifier member 138 is provided as a porous member in this embodiment, the ambient air having passed the portion of the side-face grill portion 14c adjacent the radiator 19 is oriented by its passage through the vents 138 toward the radiator 19. Hence, the ambient air may be effectively supplied to the radiator 19 without changing the current of this ambient air in particular.

### Third Embodiment

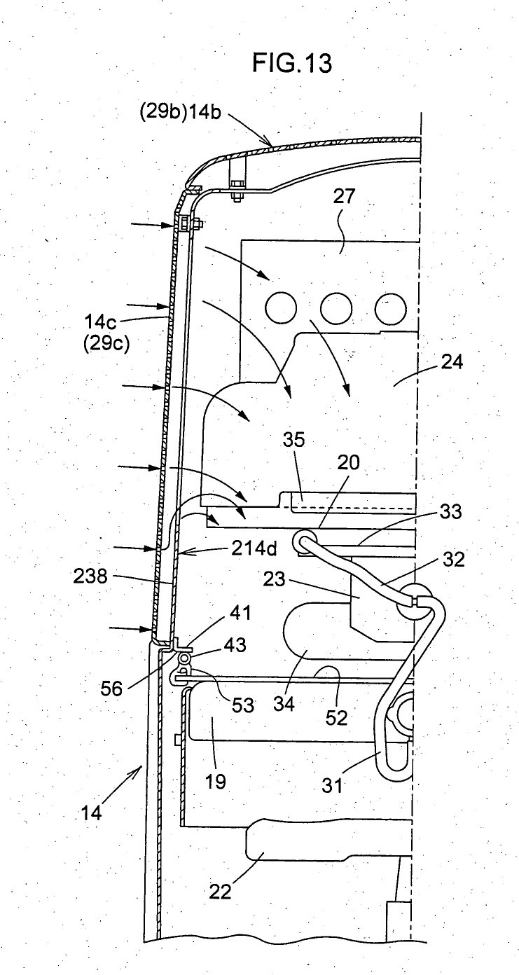

FIG. 13 shows a third embodiment of the invention. In this embodiment, a flange portion 214d provided at the rear portion of the hood body 14a is formed to extend from the rear end (on the side of the stepped portion) to the intermediate portion of the side-face grill portion 14c, so that this flange portion 214d may function as a rectifier member 238. Further, this flange portion 214d has its front end (end portion) located slightly rearward relative to the fore and aft center of the side-face grill portion 14c. Also, unlike the second embodiment described above, the flange portion 214d does not include the vents for guiding the ambient air having passed the mesh member 29c of the side-face grill portion 14c.

With the above-described construction, the hood body 14a and the rectifier members 238 may be formed integral by means of forming a resin material. As a result, this construction can omit e.g. the fastening means 37 for securing the rectifier members 238 to the inner face of the hood body 14a. Hence, this construction is advantageous for reducing the number of parts to be assembled into the hood 14 and, reducing the trouble of its assembly.

### Fourth Embodiment

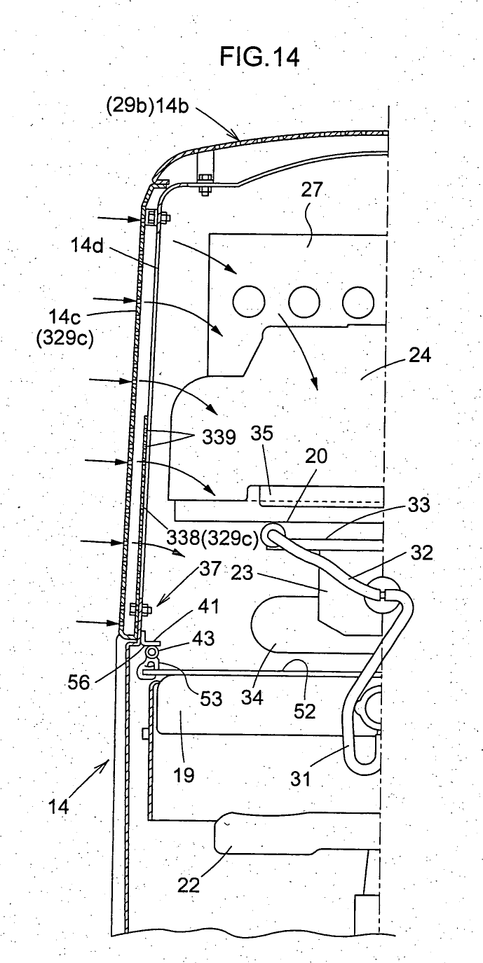

FIG. 14 shows a fourth embodiment of the present invention. In this embodiment, a rear portion of a mesh member 329c for the side-face grill portion 14c is bent in the form of letter “J” in its plan view and the leading end (front end) of the bent portion is extended from the rear end to the intermediate portion of the side-face grill portion 14c so as to constitute a rectifier member 338. The leading end (font end) is formed to be located substantially at the fore and aft center of the side-face grill portion 14c. Alternatively, this leading end may be located slightly forwardly or rearwardly of the fore and aft center of the side-face grill portion 14c.

With the above-described construction, it is not necessary to provide the rectifier member 338 as a separate member. Also, since attachment of the rectifier member 338 may be effected at one time or simultaneously with the attachment of the mesh member 329c to the hood body 14a, this construction is advantageous also for reducing the trouble of manufacture.

Incidentally, each of vents 339 formed at the bent portion (portion on the inner side of the vehicle body) of the mesh member 329c may be sized to be smaller than the mesh of the non-bent portion thereof (the portion on the outer side of the vehicle body).

The remaining portions of the second, third and fourth embodiments described above are identical to those of the first embodiment and therefore like elements thereof will be denoted with like numerals or marks, and the identical portions will not be described in repetition to avoid redundancy of description.

### Other Embodiments

The invention is not limited to the respective embodiments described above, but may be modified in various ways. Some, non-limiting examples of such variations will be described next.

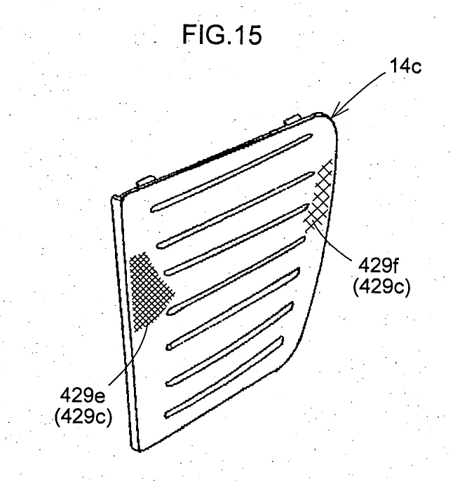

For instance, as shown in FIG. 15, the mesh member 429c of the side-face grill portion 14c may be formed so that the size of its mesh has a progressively increased aperture in the direction from its front end to its rear end (in the rearward direction). Namely, a mesh 429f located near the rear end of the mesh member 429c is formed larger than a mesh 429e located near the front end thereof. With this construction too, it is possible to reduce the velocity difference between the ambient air portion passing the front portion of the side-face grill portion 14c and the air portion passing the rear portion (adjacent the radiator 19) thereof, thus achieving equalization of velocity of the ambient air passing the side-face grill portion 14c.

Further, the front portal frame 42 may be formed as a rib projecting integrally from the inner face of the hood 14.

The seal 53 may be formed to project rearwardly from the front portal frame 42 on the side of the hood body 14a. In this case, the corresponding seal receiving face 55 should be formed on the radiator 19 (e.g. on the front face of the partition member 52), so that the seal 53 may come into contact with this face in the fore and aft direction to be compressed thereby.

The seal 53 may be formed of foamed material also.

The porous member for providing the rectifier member may be, various configurations such as a mesh, punching metal, etc.

Further, in the third embodiment, a plurality of vents may be formed in the: flange portion 214d functioning as the rectifier member 238. In this case, the fore and aft width of the flange portion 214d may be further increased.

The pivot shaft 46 may be disposed forwardly and downwardly of the radiator (i.e. at a front lower portion of the hood 14).

The tractor 1 can omit the cabin 15.

The present invention may be embodied in any other manner than described above. Various modifications thereof will be apparent to those skilled in the art, without departing the essential features thereof defined in the appended claims.

1. A working vehicle comprising:
a vehicle body;
a radiator mounted on the vehicle body;
a hood provided at a front portion of the vehicle body for covering the radiator; the hood including a hood body, a front-face grill portion provided at a front face of the hood body for introducing ambient air to the interior of the hood, and a pair of side-face grill portions provided at right and left side faces of the hood body for introducing ambient air into the interior of the hood; and
a rectifier member for controlling the flow of ambient air introduced from a rear portion of the side-face grill portion.

2. The working vehicle as defined in claim 1, wherein said rectifier member comprises a planar member disposed so as to face the inner side of the rear portion of the side-face grill portion, the planar member being configured for directing the ambient air forwardly.

3. The working vehicle as defined in claim 2, further comprising a condenser disposed forwardly of the radiator and wherein said rectifier member is adapted for directing the ambient air more forwardly of the condenser.

4. The working vehicle as defined in claim 1, wherein said each side-face grill portion includes a mesh member having a progressively increased aperture from its front end to its rear end.

5. The working vehicle as defined in claim 1, wherein said hood body includes a flange portion facing the side-face grill portion and said rectifier member is formed integrally with said flange portion.

6. The working vehicle as defined in claim 1, wherein said rectifier member comprises a planar member disposed so as to face the inner side of the rear portion of the side-face grill portion, the planar member having at least one vent and decelerating the ambient air.

7. The working vehicle as defined in claim 6, wherein the side-face grill portion includes a mesh member and said vent has an aperture smaller than that of the mesh member.

8. The working vehicle as defined in claim 7, wherein the mesh member has a progressively increased aperture from its front end to its rear end.

9. The working vehicle as defined in claim 6, wherein the rectifier member is formed integrally with the mesh member.

10. The working vehicle as defined in claim 1, further comprising a seal provided along an outer periphery of the radiator for sealing a gap between the radiator outer periphery and the inner face of the hood, and a seal receiving face provided on the inner face of the hood for coming into contact with the seal when the hood is closed; and
wherein said seal projects forwardly toward the seal receiving face and said seal is compressed when the seal receiving face comes into contact with the seal in the fore and aft direction.

11. The working vehicle as defined in claim 10, wherein the hood is pivotally openable/closable about a pivot shaft extending in the right/left direction and said pivot shaft is disposed at a higher level than the top end of the radiator.

12. The working vehicle as defined in claim 10, wherein a reinforcing frame member for reinforcing the hood is provided along the inner face of the hood body and said seal receiving face is formed in this reinforcing frame member.
